(19) United States
(12) Patent Application Publication
(10) Pub. No.: US 2016/0284452 A1
(43) Pub. Date: Sep. 29, 2016

(54) R-T-B-BASED RARE EARTH SINTERED MAGNET AND METHOD OF MANUFACTURING SAME

(71) Applicant: SHOWA DENKO K.K., Tokyo (JP)

(72) Inventors: Masaki HORIKITA, Chichibu-shi (JP); Kenichiro NAKAJIMA, Chichibu-shi (JP); Akifumi MURAOKA, Chichibu-shi (JP)

(73) Assignee: SHOWA DENKO K.K., Tokyo (JP)

(21) Appl. No.: 15/075,757

(22) Filed: Mar. 21, 2016

(30) Foreign Application Priority Data
Mar. 25, 2015 (JP) 2015-062736
Dec. 3, 2015 (JP) 2015-236770

(51) Int. Cl. H01F 1/053; C22C 38/00; B22F 3/24; B22F 3/10; H01F 41/02; C21D 9/00

(52) U.S. Cl. CPC H01F 1/0536; H01F 41/0266; C21D 9/00; B22F 3/24; B22F 3/10; C22C 38/005; B22F 2003/248

(57) ABSTRACT

An R-T-B-based rare earth sintered magnet comprising: a rare earth element R, B, a metallic element M which includes one or more metals selected from Al, Ga and Cu, a transition metal T which includes Fe as a main component and inevitable impurities, wherein the sintered magnet includes: 13 to 15.5 atom % of R, 5.0 to 6.0 atom % of B, 0.1 to 2.4 atom % of M, and T and the inevitable impurities as a balance, and wherein the sintered magnet includes more than 0 atom % and 0.01 atom % or less of Tb as the rare earth element R.

### BACKGROUND OF THE INVENTION

1. Field of the Invention

The present invention relates to an R-T-B-based rare earth sintered magnet and a method of manufacturing the same.

Priority is claimed on Japanese Patent Application No. 2015-062736, filed on Mar. 25, 2015 and Japanese Patent Application No. 2015-236770, filed on Dec. 3, 2015, the content of which is incorporated herein by reference.

2. Description of Related Art

In the related art, an R-T-B-based rare earth sintered magnet (hereinafter, in some cases, abbreviated as the “R-T-B-based magnet”) was used in motors such as a voice coil motor in a hard disc drive and engine motors for hybrid vehicles or electrical vehicles.

An R-T-B-based magnet is obtained by shaping and sintering R-T-B-based alloy powder including Nd, Fe, and B as main components. Generally, in the R-T-B-based alloy, R represents Nd or Nd some of which is substituted with other rare earth elements such as Pr, Dy, and Tb. T represents Fe or Fe some of which is substituted with other transition metals such as Co and Ni. B represents boron some of which can be substituted with C or N.

The structure of an ordinary R-T-B-based magnet is made up of, mainly, the main phase and an R-rich phase. The main phase is constituted with R₂T₁₄B. The R-rich phase is present in a grain boundary of the main phase and has a higher concentration of Nd than the main phase. The R-rich phase is also referred to as a grain boundary phase.

The composition of the R-T-B-based alloy is generally set so that, in order to increase the proportion of the main phase in the structure of the R-T-B-based magnet, the ratio between Nd, Fe, and B approximates to that of R₂T₁₄B as much as possible (for example, refer to Masato Sagawa, Permanent Magnet—Material Science and Application, second impression of the first edition published on Nov. 30, 2008, pp. 256 to 261).

In addition, an R-T-B-based magnet used in a motor for electrical vehicles is exposed to a high temperature in the motor, and thus a high coercive force (Hcj) is required.

As a technique for improving the coercive force of an R-T-B-based magnet, there is a technique in which the R in the R-T-B-based alloy is substituted from Nd to Dy or Tb. However, Dy or Tb is an eccentrically located resource and has a limited production, and thus the supply of Dy or Tb is unstable. Therefore, studies are underway regarding a technique for improving the coercive force of the R-T-B-based magnet without increasing the amount of Dy or Tb in the R-T-B-based alloy.

The present inventors studied the composition of the R-T-B-based alloy and, consequently, found that the coercive force improves when the concentration of a specific B is lower than that in the R-T-B-based alloy in the related art. In addition, the present inventors successfully developed an R-T-B-based alloy with which an R-T-B-based magnet having a high coercive force can be obtained even when the amount of Dy or Tb is zero or extremely low (for example, refer to Japanese Unexamined Patent Application, First Publication No. 2013-216965).

An R-T-B-based magnet manufactured using the R-T-B-based alloy developed by the present inventors includes a main phase made of R₂T₁₄B and a grain boundary phase including a larger amount of R than the main phase. In the R-T-B-based magnet, as the grain boundary phase, a grain boundary phase (transition metal-rich phase) having a lower concentration of rare earth elements and a higher concentration of transition metal elements than the grain boundary phase of the related art is included as well as a grain boundary phase (R-rich phase) having a high concentration of rare earth elements which has been known in the related art. The transition metal-rich phase is a phase capable of imparting a coercive force, and an R-T-B-based magnet in which the transition metal-rich phase is present in the grain boundary phase is a revolutionary technique that demolishes the conventional wisdom of the related art.

### SUMMARY OF THE INVENTION

The R-T-B-based magnet developed by the present inventors exhibits a high coercive force (Hcj) in spite of a suppressed amount of at least one of Dy and Tb, but there is a demand for an additional increase in the coercive force.

The present invention has been made in consideration of the above-described circumstances, and an object of the present invention is to provide an R-T-B-based rare earth sintered magnet having a higher coercive force (Hcj) obtained by further improving the R-T-B-based rare earth sintered magnet developed by the present inventors and a method of manufacturing the same.

The present invention employed the following means in order to achieve the above-described object.

(1) According to an aspect of the present invention there is provided an R-T-B-based rare earth sintered magnet comprising: a rare earth element R, B, a metallic element M which includes one or more metals selected from Al, Ga and Cu, a transition metal T which includes Fe as a main component and inevitable impurities, wherein the sintered magnet includes: 13 to 15.5 atom % of R, 5.0 to 6.0 atom % of B, 0.1 to 2.4 atom % of M, and T and the inevitable impurities as a balance, and wherein the sintered magnet includes more than 0 atom % and 0.01 atom % or less of Tb as the rare earth element R.

(2) In the aspect stated in the above (1), the R-T-B-based rare earth sintered magnet may include particles having an R₂T₁₄B crystal structure including Tb.

(3) In the aspect stated in the above (1) or (2), the R-T-B-based rare earth sintered magnet may satisfy the following formula (1):

0.32≦B/TRE≦0.40 (1)

wherein, in the formula (1), B represents a concentration (atom %) of a boron element and TRE represents a concentration (atom %) of total rare earth elements.

(4) In the aspect stated in the above any one of (1) to (3), the R-T-B-based rare earth sintered magnet may include 0.015 atom % to 0.10 atom % of Zr as the transition metal T.

(5) In the aspect stated in the above any one of (1) to (4), the R-T-B-based rare earth sintered magnet may include at least Ga as the metallic element M.

(6) According to an aspect of the present invention there is provided a method of manufacturing an R-T-B-based rare earth sintered magnet comprising: a sintering process of forming a sintered body using an alloy for an R-T-B-based magnet and an additive alloy, wherein the alloy for an R-T-B-based magnet includes a rare earth element R, B, a metallic element M which includes one or more metals selected from Al, Ga and Cu, a transition metal T which includes Fe as a main component, and inevitable impurities, in which the alloy for an R-T-B-based magnet includes 13 atom % to 15.5 atom % of R, 5.0 atom % to 6.0 atom % of B, 0.1 atom % to 2.4 atom % of M, and T and the inevitable impurities as a balance, and wherein the additive alloy includes a rare earth element R which essentially includes Tb, B, a metallic element M which includes one or more metals selected from Al, Ga and Cu, a transition metal T which includes Fe as a main component, and inevitable impurities, in which the additive alloy includes 13 atom % to 15.5 atom % of R, 5.0 atom % to 6.0 atom % of B, 0.1 atom % to 2.4 atom % of M, and T and the inevitable impurities as a balance; a first heat treatment process of putting the sintered body into a heat treatment furnace, carrying out a heat treatment in which the sintered body is held at a temperature in a range of 790° C. to 920° C. for 0.5 hours to 10 hours, and then cooling the sintered body at a cooling rate of 100° C./minute or higher; and a second heat treatment process of carrying out a heat treatment in which the sintered body that has undergone the first heat treatment is held at a temperature in a range of 480° C. to 620° C. for 0.05 hours to 10 hours, and then cooling the sintered body at a cooling rate of 100° C./minute or higher.

(7) In the aspect stated in the above (6), the method of manufacturing an R-T-B-based rare earth sintered magnet, in which the additive alloy may have an R₂T₁₄B crystal phase which includes Tb.

(8) In the aspect stated in the above (6) or (7), the method of manufacturing an R-T-B-based rare earth sintered magnet may satisfy the following formula (1):

0.32≦B/TRE≦0.40 (1)

wherein, in the formula (1), B represents a concentration (atom %) of a boron element and TRE represents a concentration (atom %) of total rare earth elements.

(9) In the aspect stated in the above any one of (6) to (8), the method of manufacturing an R-T-B-based rare earth sintered magnet, in which the alloy for an R-T-B-based magnet may not include Tb.

(10) In the aspect stated in the above any one of (6) to (9), the method further includes a sub process wherein the alloy for an R-T-B-based magnet and the additive alloy may be mixed together in advance prior to the sintering process.

(11) In the aspect stated in the above (10), the method of manufacturing an R-T-B-based rare earth sintered magnet, in which the amount of Tb in a mixture of the alloy for an R-T-B-based magnet and the additive alloy may be set to more than 0 atom % and 0.01 atom % or less.

According to the R-T-B-based rare earth sintered magnet of the present invention, it is possible to provide an R-T-B-based rare earth sintered magnet having a higher coercive force in spite of a suppressed amount of at least one of Dy and Tb.

According to the method of manufacturing an R-T-B-based rare earth sintered magnet of the present invention, it is possible to provide a method of manufacturing an R-T-B-based rare earth sintered magnet having a higher coercive force in spite of a suppressed amount of at least one of Dy and Tb.

### BRIEF DESCRIPTION OF THE DRAWINGS

FIG. 1 is a schematic front view illustrating an example of an apparatus for manufacturing an alloy.

FIG. 2 is a graph for descripting an example of a method of manufacturing an R-T-B-based rare earth sintered magnet of the present invention.

FIG. 3 is a graph illustrating a relationship between the amount of Tb and a coercive force in Examples 2 and 3 and Comparative Examples 3 and 4 which are R-T-B-based magnets to which Dy is not added.

FIG. 4 illustrates the observation results of R-T-B-based magnets of Example 1 and Comparative Example 4 by means of FE-EPMA in which (a) illustrates a Tb image, (b) illustrates a Nd image, (c) illustrates an Fe image, (d) illustrates a B image, and (e) illustrates a composition image.

### DETAILED DESCRIPTION OF THE INVENTION

Hereinafter, an R-T-B-based rare earth sintered magnet and a method of manufacturing the same of an embodiment of the present invention will be described in detail. The present invention is not limited to the embodiment described below and can be carried out in an appropriately modified form within the scope of the spirit of the present invention. The R-T-B-based rare earth sintered magnet of the present invention may include other elements within the scope of the object of the present invention.

“R-T-B-Based Rare Earth Sintered Magnet”

An R-T-B-based rare earth sintered magnet of the present embodiment (hereinafter, in some cases, abbreviated as the “R-T-B-based magnet”) includes a rare earth element R, a transition metal T including Fe as a main component, a metallic element M including one or more metals selected from Al, Ga, and Cu, B, and inevitable impurities. The R-T-B-based magnet of the present embodiment includes 13 atom % to 15.5 atom % of R, 5.0 atom % to 6.0 atom % of B, 0.1 atom % to 2.4 atom % of M, and a remainder of T and the inevitable impurities, and more than 0 atom % to 0.01 atom % of Tb is included as the rare earth element R.

When the amount of R in the R-T-B-based magnet is lower than 13 atom %, the coercive force of the R-T-B-based magnet becomes insufficient. In addition, when the amount of R exceeds 15.5 atom %, the degree of remanence in the R-T-B-based magnet becomes low.

The R-T-B-based magnet of the present embodiment includes Tb in a range of more than 0 atom % to 0.01 atom % and preferably includes Tb in a range of 0.002 atom % to 0.008 atom %. Although the amount of Tb is a small amount, when the magnet includes Tb in the above-described range, the coercive force (Hcj) further improves compared with the R-T-B-based magnet developed by the present inventors.

Tb is mainly present in the vicinity of a boundary between a main phase and a grain boundary phase. Although it is not possible to specify that Tb is present in the main phase or in the grain boundary phase, the coercive force is meaningfully improved with a small amount of Tb, and thus it is considered that Tb is more likely to be present in the grain boundary phase.

It is considered that, when the surfaces of fine particles of an added alloy including Tb are melted during a heat treatment and the fine particles diffuse into grain boundaries in the magnet and coat the surfaces of main phase particles, whereby the coercive force improves.

Tb in the added alloy is preferably included as one component of R for particles having an R₂T₁₄B crystal structure. This is because R₂T₁₄B crystals are slightly melted at a sintering temperature and Tb diffuses into grain boundaries in the magnet and is supplied to the outermost surface of the main phase. Particles having an R₂T₁₄B crystal structure including Tb are present in the sintered magnet since only the surface of the added alloy is molten.

The R-T-B-based magnet of the present embodiment may or may not include Dy. Examples of rare earth elements other than Dy which can be included in the R-T-B-based magnet include Sc, Y, La, Ce, Pr, Nd, Pm, Sm, Eu, Gd, Ho, Tb, Er, Tm, Yb, and Lu. Among these rare earth elements, particularly, Nd, Pr, Dy, and Tb are preferably used. In addition, R in the R-T-B-based magnet preferably includes Nd as a main component.

The metallic element M in the R-T-B-based magnet is one or more metals selected from Al, Ga, and Cu. One or more metals selected from Al, Ga, and Cu which are included in the metallic element M accelerate the generation of a transition metal-rich phase when manufacturing the R-T-B-based magnet. As a result, the coercive force (Hcj) of the R-T-B-based magnet is effectively improved.

In the R-T-B-based magnet, 0.1 atom % to 2.4 atom % of the metallic element M is included. Therefore, when manufacturing the R-T-B-based magnet, the generation of a transition metal-rich phase is accelerated. When the amount of the metallic element M in the R-T-B-based magnet is lower than 0.1 atom %, the effect of accelerating the generation of a transition metal-rich phase is insufficient. As a result, a transition metal-rich phase is not formed in the R-T-B-based magnet, an R₂T₁₇ phase is precipitated, and there is a concern that the coercive force (Hcj) of the R-T-B-based magnet may become insufficient. In order to sufficiently generate a transition metal-rich phase, the amount of the metallic element M in the R-T-B-based magnet is preferably 0.7 atom % or higher. In addition, when the amount of the metallic element M in the R-T-B-based magnet exceeds 2.4 atom %, the magnetic properties such as the remanence (Br) or the maximum energy product (BHmax) of the R-T-B-based magnet degrade. In order to ensure the remanence and the maximum energy product of the R-T-B-based magnet, the amount of the metallic element M in the R-T-B-based magnet is preferably 2.4 atom % or less.

In a case in which the metallic element M includes Cu, sintering for manufacturing the R-T-B-based magnet becomes easy, which is preferable. In a case in which the metallic element M includes Cu, when the concentration of Cu in the R-T-B-based magnet is lower than 1.0 atom %, remanence (Br) in the R-T-B-based magnet becomes favorable.

B in the R-T-B-based magnet is boron and can be partially substituted with C or N. The amount of B is in a range of 5.0 atom % to 6.0 atom %. Furthermore, the R-T-B-based magnet of the present embodiment preferably satisfies the following formula (1). In the present embodiment, when the amount of B is in the above-described range and, preferably, B/TRE is in the above-described range, the R-T-B-based magnet has a high coercive force. The reason therefor is assumed as described below.

0.32≦B/TRE≦0.40 (1)

In the formula (1), B represents a concentration (atom %) of a boron element and TRE represents a concentration (atom %) of total rare earth elements.

When the amount of B is in the above-described range and, preferably, B/TRE is in the above-described range, the amount of a transition metal and a rare earth element in the R-T-B-based magnet becomes relatively great. As a result, in a process for manufacturing the R-T-B-based magnet, the generation of a transition metal-rich phase is effectively accelerated due to the metallic element M. Therefore, the R-T-B-based magnet has a high coercive force due to the generation of a sufficient amount of a transition metal-rich phase.

In addition, when the amount of B in the R-T-B-based magnet exceeds 6.0 atom %, a B-rich phase becomes included in the R-T-B-based magnet, and the coercive force becomes insufficient. Therefore, the amount of B in the R-T-B-based magnet is set to 6.0 atom % or lower and preferably set to 5.5 atom % or less.

In addition, B/TRE represented by the formula (1) is in a range of 0.32 to 0.40 and is more preferably set in a range of 0.34 to 0.38 in order to provide a high coercive force to the R-T-B-based magnet.

T in the R-T-B-based magnet is a transition metal including Fe as a main component.

As transition metals other than Fe in T of the R-T-B-based magnet, it is possible to use a variety of elements belonging to Groups 3 to 11. Specific examples thereof include Co, Zr, Nb, and the like. In a case in which T of the R-T-B-based magnet includes Co as well as Fe, Tc (the Curie temperature) and corrosion resistance can be improved, which is preferable. In addition, as described above, in a case in which T of the R-T-B-based magnet includes Nb as well as Fe, grain growth in the main phase during sintering for manufacturing the R-T-B-based magnet is suppressed, which is preferable. In addition, in a case in which T of the R-T-B-based magnet includes a small amount (for example, 0.015 atom % to 0.10 atom %) of Zr as well as Fe, it is possible to produce an R-T-B-based magnet having a high coercive force while maintaining squareness (Hk/Hcj) at a high level.

The ratio (T/B) of the amount of T to the amount of B which are included in the R-T-B-based magnet is preferably in a range of 13 to 15.5. When the T/B of the R-T-B-based magnet is in the above-described range, the coercive force of the R-T-B-based magnet becomes higher. In addition, when the T/B of the R-T-B-based magnet is in a range of 13 to 15.5, in the process for manufacturing the R-T-B-based magnet, the generation of the transition metal-rich phase is more effectively accelerated. When the T/B of the R-T-B-based magnet is 15.5 or lower and more preferably 15 or lower, a R₂T₁₇ phase is not easily generated in the R-T-B-based magnet while being manufactured, and a favorable coercive force and favorable squareness can be obtained. In addition, when the T/B of the R-T-B-based magnet is 13 or higher and more preferably 13.5 or higher, remanence in the R-T-B-based magnet becomes favorable.

The R-T-B-based magnet of the present embodiment includes a main phase made of R₂T₁₄B and a grain boundary phase including a larger amount of R than the main phase. The grain boundary phase includes an R-rich phase and a transition metal-rich phase having a lower concentration of R and a higher concentration of transition metal elements than the R-rich phase. In the R-rich phase, the total atomic concentration of rare earth elements is 50 atom % or higher. In the transition metal-rich phase, the total atomic concentration of rare earth elements is in a range of 25 atom % to 35 atom %.

The area ratio of the transition metal-rich phase in the R-T-B-based magnet is more preferably in a range of 0.005% by area to 3% by area. When the area ratio of the transition metal-rich phase is in the above-described range, the coercive force improvement effect of the transition metal-rich phase in the grain boundary phase can be more effectively obtained. In contrast, when the area ratio of the transition metal-rich phase is lower than 0.005% by area, an R₂T₁₇ phase is precipitated, and there is a concern that the effect of improving the coercive force (Hcj) may become insufficient. In addition, when the area ratio of the transition metal-rich phase exceeds 3% by area, there is a concern that magnetic properties may be adversely affected so that remanence (Br) or the maximum energy product (BHmax) degrades, which is not preferable.

The area ratio of the transition metal-rich phase in the R-T-B-based magnet is investigated using a method described below. First, the R-T-B-based magnet is implanted in a conductive resin, and a surface parallel to an orientation direction is cut out and mirror-polished. Next, the mirror-polished surface is observed using a backscattered electron image at a magnification of approximately 1500 times, and the main phase, the R-rich phase, and the transition metal-rich phase are differentiated on the basis of contrast. After that, the area ratio of the transition metal-rich phase per cross section is computed.

The area ratio of the transition metal-rich phase can be easily adjusted by adjusting the composition of an alloy for a magnet (or an alloy for a magnet and an additive alloy) which is used as a raw material or by adjusting the conditions of at least any heat treatment of a sintering process, a first heat treatment process, and a second heat treatment process described below.

The atomic concentration of Fe in the transition metal-rich phase is preferably in a range of 50 atom % to 70 atom %. When the atomic concentration of Fe in the transition metal-rich phase is in the above-described range, the coercive force improvement effect of the transition metal-rich phase becomes more significant.

“Method of Manufacturing R-T-B-Based Rare Earth Sintered Magnet”

A method of manufacturing an R-T-B-based rare earth sintered magnet of the present invention will be described below.

“Process for Manufacturing Alloy”

As an alloy used to manufacture the R-T-B-based rare earth sintered magnet of the present invention, a cast alloy can be manufactured by, for example, casting a molten alloy having a temperature of approximately 1450° C. and a predetermined composition using a strip casting (SC) method. At this time, a treatment for accelerating the diffusion of components in the alloy by temporarily decreasing the cooling rate of the cast alloy after the casting in a temperature range of 500° C. to 900° C. (temperature-holding process) may be carried out.

Next, the obtained cast alloy is crushed, thereby producing cast alloy thin pieces. After that, the obtained cast alloy thin piece is decrepitated using a hydrogen decrepitation method or the like and is ground using a grinder. An alloy for a magnet is obtained by means of the following process.

As an alloy for an R-T-B-based rare earth sintered magnet, for example, an alloy for an R-T-B-based magnet (hereinafter, in some cases, referred to as the “first alloy”) including a rare earth element R, a transition metal T including Fe as a main component, a metallic element M including one or more metals selected from Al, Ga, and Cu, B, and inevitable impurities in which 13 atom % to 15.5 atom % of R is included, 5.0 atom % to 6.0 atom % of B is included, 0.1 atom % to 2.4 atom % of M is included, T and the inevitable impurities are included as a balance and an additive alloy (hereinafter, in some cases, referred to as the “second alloy”) including a rare earth element R essentially including Tb, a transition metal T including Fe as a main component, a metallic element M including one or more metals selected from Al, Ga, and Cu, B, and inevitable impurities in which 13 atom % to 15.5 atom % of R is included, 5.0 atom % to 6.0 atom % of B is included, 0.1 atom % to 2.4 atom % of M is included, T and the inevitable impurities are included as a balance can be jointly used.

Hereinafter, in a case in which simply the alloy for an R-T-B-based magnet is mentioned, the alloy refers to the first alloy, and, in a case in which the additive alloy is mentioned, the alloy refers to the second alloy.

As the alloy for an R-T-B-based rare earth sintered magnet, the joint use of two alloys of the alloy for an R-T-B-based magnet (first alloy) and the additive alloy (second alloy) has been exemplified, but the alloy is not limited thereto. Three or more alloys may be added.

The additive alloy used as the alloy for an R-T-B-based rare earth sintered magnet preferably has an R₂T₁₄B crystal phase including Tb. This is because, when the additive alloy has an R₂T₁₄B crystal phase including Tb, in a case in which an R-T-B-based magnet is manufactured using the additive alloy, it is possible to manufacture a magnet which has particles having a R₂T₁₄B crystal structure including Tb and exhibits a high coercive force.

In a case in which two alloys of the alloy for an R-T-B-based magnet (first alloy) and the additive alloy (second alloy) are jointly used as the alloy for an R-T-B-based rare earth sintered magnet, the two alloys or alloy thin pieces may be mixed together in any phases as long as the alloys are mixed together prior to the sintering process. For example, the two alloys may be mixed together in the phase of hydrogen decrepitation before being crushed using a crushing device or may be mixed together after being crushed.

The alloy for an R-T-B-based rare earth sintered magnet does not need to include Dy but may include Dy in order to obtain a predetermined coercive force.

Furthermore, the alloy for an R-T-B-based rare earth sintered magnet preferably satisfies the following formula (1).

0.32≦B/TRE≦0.40 (1)

In the formula (1), B represents a concentration (atom %) of a boron element and TRE represents a concentration (atom %) of total rare earth elements.

When the amount of R in the alloy for an R-T-B-based rare earth sintered magnet is lower than 13 atom %, the coercive force of the R-T-B-based magnet obtained using this alloy becomes insufficient. In addition, when the amount of R exceeds 15.5 atom %, the degree of remanence in the R-T-B-based magnet manufactured using this alloy becomes low.

As described above, in a case in which two alloys of an alloy for an R-T-B-based magnet (first alloy) and an additive alloy (second alloy) are used as the alloy for an R-T-B-based rare earth sintered magnet, examples of rare earth elements included in the alloy for an R-T-B-based magnet (first alloy) include Sc, Y, La, Ce, Pr, Nd, Pm, Sm, Eu, Gd, Dy, Tb, Ho, Er, Tm, Yb, and Lu. Among these rare earth elements, particularly, Nd, Pr, and Dy are preferably used. In addition, R in the alloy for a magnet preferably includes Nd as a main component. In addition, as the rare earth element included in the additive alloy (second alloy), Tb is essential, and examples of other rare earth elements include Sc, Y, La, Ce, Pr, Nd, Pm, Sm, Eu, Gd, Dy, Ho, Er, Tm, Yb, and Lu. Among these rare earth elements, particularly, Nd, Pr, and Dy are preferably used. In addition, R in the additive alloy preferably includes Nd as a main component.

The metallic element M in the alloy for an R-T-B-based rare earth sintered magnet is one or more metals selected from Al, Ga, and Cu. One or more metals selected from Al, Ga, and Cu which are included in the metallic element M accelerate the generation of a transition metal-rich phase when manufacturing the R-T-B-based magnet. As a result, the coercive force (Hcj) of the R-T-B-based magnet is effectively improved.

In the alloy for an R-T-B-based rare earth sintered magnet, 0.1 atom % to 2.4 atom % of the metallic element M is included. Therefore, the R-T-B-based magnet including the R-rich phase and the transition-rich phase is obtained by sintering and heat treating the alloy for a magnet. When the amount of the metallic element M in the alloy for a magnet is lower than 0.1 atom %, the effect of accelerating the generation of a transition metal-rich phase is insufficient. As a result, a transition metal-rich phase is not formed in the R-T-B-based magnet, and there is a concern that the coercive force (Hcj) of the R-T-B-based magnet may become insufficient. In order to sufficiently generate a transition metal-rich phase, the amount of the metallic element M in the alloy for a magnet is preferably 0.7 atom % or higher. In addition, when the amount of the metallic element M in the alloy for a magnet exceeds 2.4 atom %, the magnetic properties such as the remanence (Br) or the maximum energy product (BHmax) of the R-T-B-based magnet degrade. In order to ensure the remanence and the maximum energy product of the R-T-B-based magnet, the amount of the metallic element M in the alloy for a magnet is preferably 2.4 atom % or lower.

In a case in which the metallic element M includes Ga, Ga has a strong effect of suppressing the generation of a R₂T₁₇ phase, and thus it is possible to prevent the coercive force or squareness from being decreased due to the generation of the R₂T₁₇ phase. Therefore, the metallic element M preferably includes Ga.

In a case in which the metallic element M includes Cu, sintering of the alloy for a magnet becomes easy, which is preferable. In a case in which the metallic element M includes Cu, when the concentration of Cu in the alloy for a magnet is lower than 1.0 atom %, remanence (Br) in the R-T-B-based magnet manufactured using the alloy for a magnet becomes favorable.

B in the alloy for an R-T-B-based rare earth sintered magnet is boron and can be partially substituted with C or N. The amount of B is in a range of 5.0 atom % to 6.0 atom %, and B/TRE which is the ratio of the concentration of B to the concentration of the rare earth element preferably satisfies the formula (1). Therefore, in the present embodiment, an R-T-B-based magnet manufactured using the alloy for a magnet has a high coercive force. The reason therefor is assumed as described below.

When the amount of B and B/TRE of the alloy for an R-T-B-based rare earth sintered magnet are in the above-described ranges, in an R-T-B-based magnet manufactured using the alloy for a magnet, grain boundary phases are uniformly dispersed, and a high coercive force is obtained. Furthermore, when the amount of B and B/TRE of the alloy for a magnet are in the above-described ranges, the amount of the transition metal and the rare earth element in the alloy for a magnet becomes relatively great. As a result, in a process for manufacturing the R-T-B-based magnet, the generation of a transition metal-rich phase is effectively accelerated. Therefore, the R-T-B-based magnet manufactured using the alloy for a magnet has a high coercive force due to the generation of a sufficient amount of a transition metal-rich phase.

When the amount of B in the alloy for an R-T-B-based rare earth sintered magnet is lower than 5.0 atom %, there are cases in which a R₂T₁₇ phase is precipitated in the R-T-B magnet and the coercive force is not sufficient. When the amount of B in the alloy for a magnet exceeds 6.0 atom %, a B-rich phase becomes included in the R-T-B-based magnet manufactured using this alloy, and the coercive force becomes insufficient. Therefore, the amount of B in the alloy for a magnet is set to 6.0 atom % or lower and preferably set to 5.5 atom % or lower.

T in the alloy for an R-T-B-based rare earth element sintered magnet is a transition metal including Fe as a main component. As transition metals other than Fe in T of the R-T-B-based magnet, it is possible to use a variety of elements belonging to Groups 3 to 11. Specific examples thereof include Co, Zr, Nb, and the like. In a case in which T of the R-T-B-based magnet includes Co as well as Fe, Tc (the Curie temperature) and corrosion resistance can be improved, which is preferable. In addition, as described above, in a case in which T of the R-T-B-based magnet includes Nb as well as Fe, grain growth in the main phase during sintering for manufacturing the R-T-B-based magnet is suppressed, which is preferable. In addition, in a case in which T of the R-T-B-based magnet includes a small amount (for example, 0.015 atom % to 0.10 atom %) of Zr as well as Fe, it is possible to produce an R-T-B-based magnet having a high coercive force while maintaining squareness (Hk/Hcj) at a high level.

The ratio (T/B) of the amount of T to the amount of B which are included in the alloy for an R-T-B-based rare earth sintered magnet is preferably in a range of 13 to 15.5. When the T/B of the alloy for a magnet is in the above-described range, the coercive force of the R-T-B-based magnet manufactured using the alloy for a magnet becomes higher. In addition, when the T/B of the alloy for a magnet is in a range of 13 to 15.5, in the process for manufacturing the R-T-B-based magnet, the generation of the transition metal-rich phase is more effectively accelerated. When the T/B of the alloy for a magnet is 15.5 or lower and more preferably 15 or lower, the generation of a R₂T₁₇ phase in the R-T-B-based magnet manufactured using the alloy for a magnet is prevented, and it is possible to prevent a decrease in the coercive force or squareness. In addition, when T/B in the alloy for a magnet is 13 or higher and more preferably 13.5 or higher, remanence in the R-T-B-based magnet manufactured using the alloy for a magnet becomes favorable.

When the total concentration of oxygen, nitrogen, and carbon included as impurities and the like in the alloy for an R-T-B-based rare earth sintered magnet is high, in the sintering process, these elements and the rare earth element R bond to each other, and thus the rare earth element R is consumed. Therefore, out of the rare earth element R in the alloy for a magnet, in the first heat treatment process and the second heat treatment process carried out after the sintering process, the amount of the rare earth element R used as a raw material for the transition metal-rich phase decreases. As a result, the amount of the transition metal-rich phase generated becomes low, and there is a concern that the coercive force of the R-T-B-based magnet may become insufficient.

Therefore, the total concentration of oxygen, nitrogen, and carbon in the alloy for an R-T-B-based rare earth sintered magnet is preferably 2 atom % or lower. When the total concentration of oxygen, nitrogen, and carbon in the alloy for an R-T-B-based rare earth sintered magnet is set to 2 atom % or lower, it is possible to suppress the rare earth element R being consumed in the sintering process and to ensure the amount of the transition metal-rich phase generated. Therefore, an R-T-B-based magnet having a high coercive force (Hcj) is obtained.

The alloy for an R-T-B-based rare earth sintered magnet includes a main phase made of R₂T₁₄B and a grain boundary phase including a larger amount of R than the main phase.

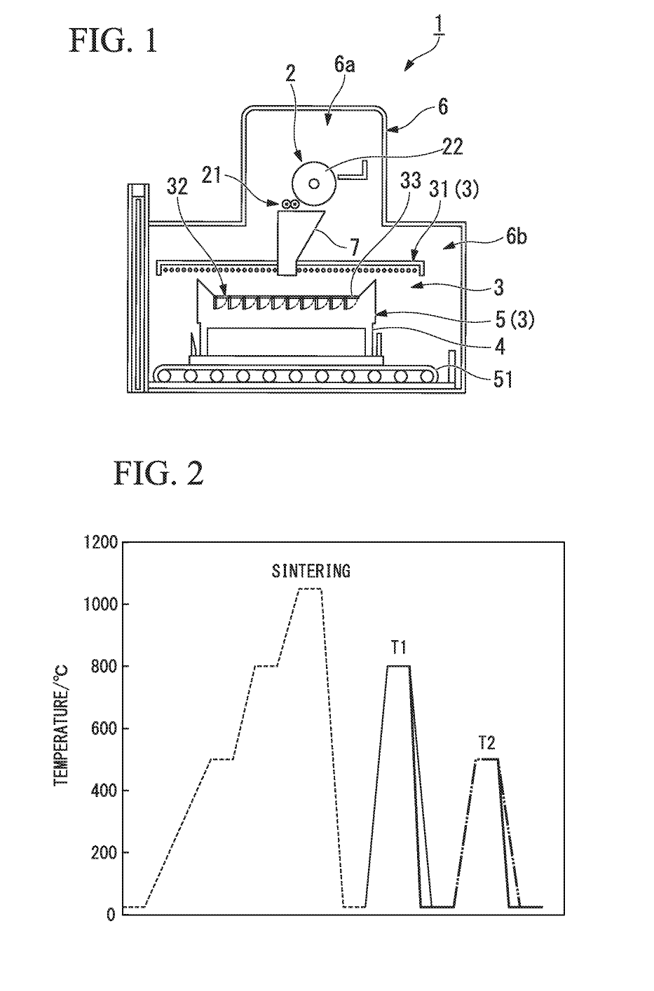

As an example of a process for manufacturing the alloy for an R-T-B-based rare earth sintered magnet of the present invention, a manufacturing method in which a manufacturing apparatus illustrated in FIG. 1 will be described.

(Apparatus for Manufacturing Alloy)

FIG. 1 is a schematic front view illustrating an example of an apparatus for manufacturing an alloy.

An apparatus for manufacturing an alloy 1 illustrated in FIG. 1 includes a casting device 2, a crushing device 21, a heating device 3 disposed below the crushing device 21, and a storage container 4 disposed below the heating device 3.

The crushing device 21 is a device that crushes a cast alloy ingot cast using the casting device 2 so as to produce cast alloy thin pieces. As illustrated in FIG. 1, a hopper 7 that guides the cast alloy thin pieces onto an openable stage group 32 of the heating device 3 is provided between the crushing device 21 and the openable stage group 32.

The heating device 3 is constituted with a heating heater 31 and a container 5. The container 5 includes a storage container 4 and the openable stage group 32 installed in the upper portion of the storage container 4. The openable stage group 32 is made up of a plurality of openable stages 33. The openable stages 33 hold the cast alloy thin pieces supplied from the crushing device 21 when “closed” and send the cast alloy thin pieces to the storage container 4 when “opened”.

In addition, the manufacturing apparatus 1 includes a belt conveyer 51 (moving device) that makes the container 5 movable, and the belt conveyer 51 enables the container 5 to move in the right and left direction in FIG. 1.

In addition, the manufacturing apparatus 1 illustrated in FIG. 1 includes a chamber 6. The chamber 6 includes a casting chamber 6a and a heat retention and storage chamber 6b which is installed below the casting chamber 6a and is communicated with the casting chamber 6. The casting device 2 is housed in the casting chamber 6a, and the heating device 3 is housed in the heat retention and storage chamber 6b.

In the present embodiment, in order to manufacture the alloy for an R-T-B-based rare earth sintered magnet, first, a molten alloy having a temperature of approximately 1450° C. and a predetermined composition is prepared in a melting device not illustrated. Next, the obtained molten alloy is supplied to a cooling roll 22 made of a water cooling copper roll in the casting device 2 using a tundish not illustrated and is solidified, thereby producing a cast alloy. After that, the cast alloy is detached from the cooling roll 22 and is made to pass through crushing rolls in the crushing device 21 so as to be crushed, thereby producing cast alloy thin pieces.

The crushed cast alloy thin pieces are made to pass through the hopper 7 and are piled up on the openable stages 33 causing the openable stage group 32 disposed below the hopper 7 to be in a “closed” state. The cast alloy thin pieces piled up on the openable stages 33 are heated using the heating heater 31.

In the present embodiment, while the temperature of the manufactured cast alloy is decreased from higher than 800° C. to lower than 500° C., a temperature-holding process of maintaining the cast alloy at a constant temperature for 10 seconds to 120 seconds is carried out. In the present embodiment, the cast alloy thin pieces having a temperature in a range of 800° C. to 500° C. are supplied onto the openable stages 33 and begin to be heated using the heating heater 31 immediately after the cast alloy thin pieces are piled up on the openable stages 33. In the above-described manner, a temperature-holding process of maintaining the cast alloy at a constant temperature for 10 seconds to 120 seconds is initiated.

In addition, after a predetermined period of time elapses, the openable stages 33 fall into an “open” state and the cast alloy thin pieces piled up on the openable stages 33 are dropped to the storage container 4. Therefore, heat from the heating heater 31 does not reach the cast alloy thin pieces, the cooling of the cast alloy thin pieces is initiated again, and the temperature-holding process ends.

In a case in which the temperature-holding process is carried out, it is assumed that, among elements in the cast alloy, due to the redisposition of elements migrating in the cast alloy, the component interchange between the metallic element M including one or more metals selected from Al, Ga, and Cu and B is accelerated; therefore, a portion of B in a region serving as an alloy grain boundary phase migrates toward the main phase, and a portion of the metallic element M in a region serving as the main phase migrates toward the alloy grain boundary phase; consequently, the intrinsic magnetic properties of the main phase can be exhibited, and thus the coercive force of an R-T-B-based magnet for which the cast alloy is used becomes high.

In a case in which the temperature of the cast alloy in the temperature-holding process is higher than 800° C., there is a concern that the alloy structure may coarsen. In addition, in a case in which the temperature-holding duration exceeds 120 seconds, there are cases in which the productivity is adversely affected.

In addition, in a case in which the temperature of the cast alloy in the temperature-holding process is lower than 500° C. or the temperature-holding duration is shorter than 10 seconds, there are cases in which the effect of the redisposition of the element occurring in the temperature-holding process is not sufficiently obtained.

Meanwhile, in the present invention, the temperature-holding process is carried out using a method in which the cast alloy thin pieces piled up on the openable stages 33 are heated using the heating heater 31 in a temperature range of 800° C. to 500° C., but there is no limitations regarding the method of the temperature-holding process as long as the cast alloy having a temperature exceeding 800° C. can be maintained at a certain temperature for 10 seconds to 120 seconds until the temperature of the cast alloy reaches lower than 500° C.

In addition, in the method of manufacturing the alloy for an R-T-B-based rare earth sintered magnet of the present embodiment, the inside of the chamber 6 for manufacturing the R-T-B-based alloy is preferably set to a reduced-pressure atmosphere of an inert gas. Furthermore, in the present embodiment, at least a portion of a casting process is preferably carried out in an atmosphere including helium. Compared with argon, helium has a better capability of dissipating heat from the cast alloy and is capable of more easily increasing the cooling rate of the cast alloy.

Examples of a method of carrying out at least a portion of the casting process in an atmosphere including helium include a method in which helium is supplied as an inert gas into the casting chamber 6a in the chamber 6 at a predetermined flow rate. In this case, an atmosphere including helium is formed in the casting chamber 6a, and thus it is possible to efficiently cool the surface, which is not in contact with the cooling roll 22, of the cast alloy which is cast using the casting device 2 and quenched using the cooling roll 22. Therefore, the cooling rate of the cast alloy increases, the grain diameter in the alloy structure decreases, the cast alloy obtains excellent crushing properties, a fine alloy structure in which the gap between the alloy grain boundary phases is 3 μm or smaller is easily obtained, and the coercive force of an R-T-B-based magnet manufactured using this cast alloy can be improved. In addition, in a case in which an atmosphere including helium is formed in the casting chamber 6a, the cooling rate of the cast alloy increases, and thus the temperature of the cast alloy thin pieces piled up on the openable stages 33 can be easily set to 800° C. or lower.

In addition, in the method of manufacturing the R-T-B-based alloy of the present embodiment, the cast alloy thin pieces that have undergone the temperature-holding process are preferably cooled in an atmosphere including helium. In such a case, the cooling rate of the cast alloy thin pieces which are a cast alloy that has undergone the temperature-holding process increases, and thus the alloy structure becomes finer, the crushing properties are excellent, and a fine alloy structure in which the gap between the alloy grain boundary phases is 3 μm or smaller is easily obtained. Examples of a method of cooling the cast alloy thin pieces that have undergone the temperature-holding process in an atmosphere including helium include a method in which helium is supplied into the storage container 4 housing the cast alloy thin pieces dropped from the openable stages 33 at a predetermined flow rate.

Meanwhile, in the present embodiment, a case in which the alloy for an R-T-B-based rare earth sintered magnet is manufactured using the SC method including the temperature-holding process has been described, but the alloy for an R-T-B-based rare earth sintered magnet used in the present invention may be an alloy manufactured using the SC method including the temperature-holding process and is not limited to alloys manufactured using the SC method. For example, the alloy for an R-T-B-based rare earth sintered magnet may be manufactured using a centrifugal casting method, a book molding method, or the like.

The hydrogen decrepitation method is carried out in an order in which, for example, hydrogen is stored in the cast alloy thin pieces at room temperature, the cat alloy thin pieces are heat treated in hydrogen having a temperature of approximately 300° C., then, hydrogen present between lattices in the main phase is degassed by reducing the pressure, and then the cat alloy thin pieces are heat treated at a temperature of approximately 500° C., thereby removing hydrogen bonded to the rare earth elements in the grain boundary phases. In the hydrogen decrepitation method, the volume of the cast alloy thin pieces storing hydrogen expands, and thus a number of cracks are easily generated in the alloy, and the alloy is decrepitated.

In addition, as a method of crushing the hydrogen-decrepitated cast alloy thin pieces, jet milling or the like is used. The hydrogen-decrepitated cast alloy thin pieces are put into a jet mill and are finely crushed to an average grain size in a range of 1 μm to 4.5 μm using high-pressure nitrogen of, for example, 0.6 MPa, thereby producing powder. A small average grain size of the powder enables the improvement of the coercive force of a sintered magnet. However, when the grain size is too small, the powder surfaces are likely to be oxidized and, conversely, the coercive force decreases.

[Process for Manufacturing Magnet Using Alloy]

Next, a method of manufacturing an R-T-B-based magnet using the alloy for an R-T-B-based rare earth sintered magnet obtained in the above-described manner will be described.

Examples of a method of manufacturing the R-T-B-based magnet of the present embodiment include a method in which 0.02% by mas to 0.03% by mass of zinc stearate is added as a lubricant to the powder of the alloy for an R-T-B-based rare earth sintered magnet, the powder is pressed using a shaping machine in a traverse magnetic field, is sintered in a vacuum, and then is heat treated.

(Sintering Process)

A heat treatment for sintering a compact is not particularly limited and, for example, can be carried out under heat treatment conditions described below.

The atmosphere in a heat treatment furnace (in a chamber) during sintering can be set to, for example, a vacuum atmosphere or an inert gas atmosphere. The atmosphere in a heat treatment furnace during sintering is preferably a vacuum atmosphere or an argon gas atmosphere and more preferably a vacuum atmosphere in order to prevent damage in a compact made of the alloy for a magnet due to oxidization.

FIG. 2 is a graph for descripting an example of a method of manufacturing the R-T-B-based rare earth sintered magnet of the present invention in which the relationship between the heat treatment duration and the heat treatment temperature in a sintering process, a first heat treatment process, and a second heat treatment process. Meanwhile, in each of the graphs of the first heat treatment process and the second heat treatment process, quenching according to the present invention is indicated using a thick line, and a solid line which is not a thick line and a dotted line indicate references of a case that is not quenching.

In the present embodiment, the heat treatment for sintering the compact can be carried out under well-known conditions of the related art, and the conditions are not particularly limited. For example, it is possible to use a method of the heat treatment for sintering the compact in which a first heat treatment is carried out in order to remove an organic substance as illustrated in FIG. 2; after that, a second heat treatment is carried out in order to reduce a hydroxide by further increasing the temperature; after that, a third heat treatment is carried out in order for liquid-phase sintering by further increasing the temperature. In the heat treatment for sintering the compact, the temperature may be increased in a stepwise manner by carrying out a process of holding the compact at a certain temperature for a predetermined period of time once or plural times (twice in an example illustrated in FIG. 2, the first heat treatment and the second heat treatment) as described above until the peak temperature (the temperature of the third heat treatment in the example illustrated in FIG. 2) is reached or may be continuously increased without holding the compact at a certain temperature until the peak temperature is reached.

(First Heat Treatment Process)

In the first heat treatment, a sintered body obtained after sintering is put into a heat treatment furnace, and a heat treatment is carried out under conditions described below.

The heat treatment atmosphere in the first heat treatment process is not particularly limited and can be set to, for example, a vacuum atmosphere or an inert gas atmosphere. The atmosphere in the heat treatment furnace during the first heat treatment is preferably a vacuum or an argon atmosphere in order to prevent oxidization.

In the first heat treatment process, a heat treatment in which the compact is held at a temperature, which is indicated by a reference T1 in FIG. 2, set in a range of 790° C. to 920° C. for 0.5 hours to 10 hours is carried out, and the compact is cooled at a cooling rate of 100° C./minute or higher (refer to FIG. 2). It is considered that, when the temperature, the holding duration, and the cooling rate in the heat treatment are set in the above-described ranges, Tb in the additive alloy diffuses into the entire first alloy from the additive alloy and is uniformly supplied to the vicinity of the boundary between the main phase and the grain boundary phase and thus contributes to improving the coercive force.

The cooling rate after holding the compact at the temperature of T1 for a predetermined period of time is 100° C./minute or higher. The cooling rate is preferably 200° C./minute or higher, more preferably 300° C./minute or higher, and still more preferably 500° C./minute or higher. The upper limit of the cooing rate is preferably 3000° C./minute or lower, more preferably 2000° C./minute or lower, and still more preferably 1500° C./minute or lower in order to prevent a problem of the strength of the sintered body being decreased due to residual stress in the compact. The upper limit of the cooling rate can be achieved by, for example, cooling the sintered body using water.

In addition, when the heat treatment temperature is 790° C. or higher, the composition of the grain boundary phase becomes uniform, which is preferable. In addition, when the heat treatment temperature is 920° C. or lower, grain growth in the main phase of the sintered body can be suppressed. Therefore, the heat treatment temperature is set to 920° C. or lower. In order to more effectively suppress the grain growth in the main phase of the sintered body, the heat treatment temperature is preferably set to 910° C. or lower.

When the holding duration of the heat treatment is shorter than 0.5 hours, the duration is not long enough for the composition of the grain boundary phase to be uniformly redisposed, and a coercive force-improving effect cannot be sufficiently obtained. Therefore, the holding duration of the heat treatment is set to 0.5 hours or longer and preferably set to 0.75 hours or longer. In addition, when the holding duration is set to 10 hours or shorter, grain growth in the main phase of the sintered body can be suppressed. Therefore, the holding duration in the first heat treatment process is set to ten hours or shorter and preferably set to eight hours or shorter.

(Second Heat Treatment Process)

In the second heat treatment, the sintered body that has undergone the first heat treatment is put into a heat treatment furnace, and a heat treatment is carried out under conditions described below.

The heat treatment atmosphere in the second heat treatment process is not particularly limited and can be set to, for example, a vacuum atmosphere or an inert gas atmosphere.

In the second heat treatment process, a heat treatment in which the compact that has undergone the first heat treatment is held at a temperature, which is indicated by a reference T2 in FIG. 2, set in a range of 480° C. to 620° C. for 0.05 hours to 10 hours is carried out, and the compact is cooled at a cooling rate of 100° C./minute or higher (refer to FIG. 2). When the temperature, the holding duration, and the cooling rate in the heat treatment are set in the above-described ranges, atoms in the R-T-B-based magnet are redisposed. As a result, the sintered body that has undergone the second heat treatment process has a high coercive force (Hcj).

The cooling rate after holding the compact at the temperature of T2 for a predetermined period of time is 100° C./minute or higher. The cooling rate is preferably 200° C./minute or higher, more preferably 300° C./minute or higher, and still more preferably 500° C./minute or higher. The upper limit of the cooing rate is preferably 3000° C./minute or lower, more preferably 2000° C./minute or lower, and still more preferably 1500° C./minute or lower in order to prevent a problem of the strength of the sintered body being decreased due to residual stress in the compact.

When the heat treatment temperature is 480° C. or higher, an effect of the redisposition of atoms in the R-T-B-based magnet is sufficiently obtained. Therefore, the heat treatment temperature is set to 480° C. or higher. When the heat treatment temperature is 520° C. or higher, the coercive force-improving effect of the second heat treatment process becomes significant, which is preferable. In addition, when the heat treatment temperature is 620° C. or lower, a decrease in the squareness of the R-T-B-based magnet due to a reaction between grain boundary phase components in the sintered body is suppressed. Therefore, the heat treatment temperature in the second heat treatment process is set to 620° C. or lower. In order to more effectively suppress a decrease in the squareness of the R-T-B-based magnet due to the second heat treatment process, the heat treatment temperature is preferably set to 575° C. or lower.

When the holding duration of the heat treatment is shorter than 0.05 hours, atoms are not sufficiently redisposed in the sintered body that has undergone the second heat treatment process, and the coercive force-improving effect of the second heat treatment process cannot be obtained. Therefore, the holding duration of the heat treatment is preferably set to 0.05 hours or longer. In addition, when the holding duration exceeds 10 hours, particles agglomerate, and thus the coercive force-improving effect of the second heat treatment process weakens. Therefore, the holding duration in the second heat treatment process is preferably set to 10 hours or shorter.

In addition, the effect of improving the coercive force (Hcj) obtained in the R-T-B-based magnet of the present invention is assumed to result from, firstly, the transition metal-rich phase including a high concentration of Fe formed in the grain boundary phase. The area ratio of the transition metal-rich phase in the R-T-B-based magnet of the present invention is preferably in a range of 0.005% by area to 3% by area and more preferably in a range of 0.1% by area to 2% by area.

When the area ratio of the transition metal-rich phase is in the above-described range, the coercive force-improving effect of the transition metal-rich phase included in the grain boundary phase is more effectively obtained. In contrast, when the area ratio of the transition metal-rich phase is lower than 0.005% by area, there is a concern that the effect of improving the coercive force (Hcj) may become insufficient. In addition, when the area ratio of the transition metal-rich phase exceeds 3% by area, magnetic properties may be adversely affected so that remanence (Br) or the maximum energy product ((BH)max) degrades, which is not preferable.

Furthermore, the effect of improving the coercive force (Hcj) obtained in the R-T-B-based magnet of the present invention is assumed to result from, secondly, the fact that more than 0 atom % and 0.01 atom % or less of Tb is included as a rare earth element R, and thus the surface of the main phase is coated with Tb.

The atomic concentration of Fe in the transition metal-rich phase is preferably in a range of 50 atom % to 70 atom %. When the atomic concentration of Fe in the transition metal-rich phase is in the above-described range, the effect of the inclusion of the transition metal-rich phase is more effectively obtained. In contrast, when the atomic concentration of Fe in the transition metal-rich phase is below the above-described range, there is a concern that the effect of improving the coercive force (Hcj) generated due to the inclusion of the transition metal-rich phase in the grain boundary phase may become insufficient. In addition, when the atomic concentration of Fe in the transition metal-rich phase is above the above-described range, there is a concern that a R₂T₁₇ phase or Fe may be precipitated and thus the magnetic properties may be adversely affected.

The R-T-B-based magnet of the present embodiment has a B/TRE amount satisfying the formula (1) and is produced by shaping and sintering an R-T-B-based alloy including 0.1 atom % to 2.4 atom % of the metallic element M. In addition, the grain boundary phase includes the R-rich phase and the transition metal-rich phase and has a lower total atomic concentration of rare earth elements and a higher atomic concentration of Fe in the transition metal-rich phase than that in the R-rich phase. As a result, the R-T-B-based magnet has a high coercive force and excellent magnetic properties which allow the R-T-B-based magnet to be preferably used for motors while suppressing the amount of Dy.

Meanwhile, in the present embodiment, the coercive force may be further improved by attaching a Dy metal or a Dy compound to the surface of the sintered R-T-B-based magnet, heat treating the magnet, and diffusing Dy in the sintered magnet, thereby producing an R-T-B-based magnet having a higher concentration of Dy on the surface of the sintered magnet than in the sintered magnet.

Specific examples of a method of manufacturing the R-T-B-based magnet having a higher concentration of Dy on the surface of the sintered magnet than in the sintered magnet include the following method. For example, the sintered R-T-B-based magnet is immersed in a coating liquid produced by mixing a solvent such as ethanol and dysprosium fluoride (DyF₃) at a predetermined ratio, thereby coating the R-T-B-based magnet with the coating liquid. After that, the R-T-B-based magnet coated with the coating liquid is subjected to a diffusion process in which a heat treatment is carried out in two separate stages. Specifically, the R-T-B-based magnet coated with the coating liquid is subjected to a first heat treatment in which the magnet is heated at a temperature of 900° C. for one hour in an argon atmosphere, and the R-T-B-base magnet which has undergone the first heat treatment is temporarily cooled to room temperature. After that, again, the R-T-B-based magnet is subjected to a second heat treatment in which the magnet is heated at a temperature of 500° C. for one hour in an argon atmosphere and is cooled to room temperature.

As a method of attaching a Dy metal or a Dy compound to the surface of the sintered R-T-B-based magnet other than the above-described method, a method in which a metal is gasified and a gaseous film is attached to the surface of the magnet, a method in which an organic metal is dissolved and a film is attached to the surface, or the like may be used.

Meanwhile, the sintered R-T-B-based magnet may be heat treated after a Tb metal or a Tb compound is attached to the surface of the magnet instead of a Dy metal or a Dy compound. In this case, for example, when the surface of the sintered R-T-B-based magnet is coated with a coating liquid including a Tb fluoride, the magnet is heat treated, and Tb is diffused in the sintered magnet, it is possible to produce an R-T-B-based magnet having a high concentration of Tb on the surface of the sintered magnet than in the sintered magnet, and the coercive force can be further improved.

In addition, the coercive force may be further improved by depositing metallic Dy or metallic Tb on the surface of the R-T-B-based magnet, heat treating the magnet, and diffusing Dy or Tb in the sintered magnet. For the R-T-B-based magnet of the present embodiment, the above-described technique can be used without any adverse influences.

The coercive force (Hcj) of the R-T-B-based magnet is preferably higher. In a case in which the R-T-B-based magnet is used as a magnet for motors for electric power steering such as vehicles, the coercive force is preferably 20 kOe or higher, and in a case in which the R-T-B-based magnet is used as a magnet for motors for electrical vehicles, the coercive force is preferably 30 kOe or higher. When the coercive force (Hcj) is lower than 30 kOe in a magnet for motors for electrical vehicle, there are cases in which the heat resistance is insufficient for motors.

### EXAMPLES

### Examples 1 to 10 and Comparative Examples 1 to 9

Nd metal (purity: 99 wt % or higher), Pr metal (purity: 99 wt % or higher), Dy metal (purity: 99 wt % or higher), ferroboron (Fe: 80 wt %, B: 20 wt %), iron metal (purity: 99 wt % or higher), Al metal (purity: 99 wt % or higher), Ga metal (purity: 99 wt % or higher), Cu metal (purity: 99 wt % or higher), Co metal (purity: 99 wt % or higher), Zr metal (purity: 99 wt % or higher), and Tb metal (purity: 99 wt % or higher) were weighed so as to obtain the alloy compositions of alloys M1 to M5 (first alloys) and an alloy Al (additive alloy (second alloy)) shown in Table 1 and were loaded into an alumina crucible.

TABLE 1
at %

| | | Mixing ratio | | | | | | | | | | | | | |
|---|---|---|---|---|---|---|---|---|---|---|---|---|---|---|---|
| | | (weight ratio) | TRE | Nd | Pr | Dy | Tb | Al | Fe | Ga | Cu | Co | Zr | B | B/TRE |
| Sintered | Alloy M1 | 0.98 | 14.6 | 10.7 | 3.8 | 0.0 | 0.000 | 0.42 | bal. | 0.48 | 0.12 | 1.01 | 0.11 | 5.50 | 0.378 |
| body A | Alloy A1 | 0.02 | 14.6 | 10.2 | 3.6 | 0.0 | 0.821 | 0.43 | bal. | 0.48 | 0.13 | 1.00 | 0.12 | 5.56 | 0.380 |
| | After mixing | | 14.6 | 10.7 | 3.8 | 0.0 | 0.016 | 0.42 | bal. | 0.48 | 0.12 | 1.01 | 0.11 | 5.50 | 0.378 |
| Sintered | Alloy M1 | 0.99 | 14.6 | 10.7 | 3.8 | 0.0 | 0.000 | 0.42 | bal. | 0.48 | 0.12 | 1.01 | 0.11 | 5.50 | 0.378 |
| body B | Alloy A1 | 0.01 | 14.6 | 10.2 | 3.6 | 0.0 | 0.821 | 0.43 | bal. | 0.48 | 0.13 | 1.00 | 0.12 | 5.56 | 0.380 |
| | After mixing | | 14.6 | 10.7 | 3.8 | 0.0 | 0.008 | 0.42 | bal. | 0.48 | 0.12 | 1.01 | 0.11 | 5.50 | 0.378 |
| Sintered | Alloy M1 | 0.9975 | 14.6 | 10.7 | 3.8 | 0.0 | 0.000 | 0.42 | bal. | 0.48 | 0.12 | 1.01 | 0.11 | 5.50 | 0.378 |
| body C | Alloy A1 | 0.0025 | 14.6 | 10.2 | 3.6 | 0.0 | 0.821 | 0.43 | bal. | 0.48 | 0.13 | 1.00 | 0.12 | 5.56 | 0.380 |
| | After mixing | | 14.6 | 10.7 | 3.8 | 0.0 | 0.002 | 0.41 | bal. | 0.48 | 0.13 | 0.99 | 0.12 | 5.50 | 0.378 |
| Sintered | Alloy M1 | 1 | 14.6 | 10.7 | 3.8 | 0.0 | 0.000 | 0.42 | bal. | 0.48 | 0.12 | 1.01 | 0.11 | 5.50 | 0.378 |
| body D | | | | | | | | | | | | | | | |
| Sintered | Alloy M2 | 0.9975 | 14.6 | 10.7 | 3.9 | 0.0 | 0.000 | 0.46 | bal. | 0.49 | 0.13 | 0.99 | 0.02 | 5.32 | 0.365 |
| body E | Alloy A1 | 0.0025 | 14.6 | 10.2 | 3.6 | 0.0 | 0.821 | 0.43 | bal. | 0.48 | 0.13 | 1.00 | 0.12 | 5.56 | 0.380 |
| | After mixing | | 14.5 | 10.7 | 3.9 | 0.0 | 0.002 | 0.46 | bal. | 0.49 | 0.13 | 0.99 | 0.02 | 5.32 | 0.366 |
| Sintered | Alloy M2 | 1 | 14.6 | 10.7 | 3.9 | 0.0 | 0.000 | 0.46 | bal. | 0.49 | 0.13 | 0.99 | 0.02 | 5.32 | 0.365 |
| body F | | | | | | | | | | | | | | | |
| Sintered | Alloy M3 | 0.9975 | 14.7 | 10.2 | 3.6 | 0.8 | 0.000 | 0.42 | bal. | 0.48 | 0.14 | 0.99 | 0.03 | 5.28 | 0.360 |
| body G | Alloy A1 | 0.0025 | 14.6 | 10.2 | 3.6 | 0.0 | 0.821 | 0.43 | bal. | 0.48 | 0.13 | 1.00 | 0.12 | 5.56 | 0.380 |
| | After mixing | | 14.7 | 10.2 | 3.6 | 0.8 | 0.002 | 0.42 | bal. | 0.48 | 0.14 | 0.99 | 0.03 | 5.28 | 0.360 |
| Sintered | Alloy M3 | 1 | 14.7 | 10.2 | 3.6 | 0.8 | 0.000 | 0.42 | bal. | 0.48 | 0.14 | 0.99 | 0.03 | 5.28 | 0.360 |
| body H | | | | | | | | | | | | | | | |
| Sintered | Alloy M4 | 0.9975 | 14.0 | 9.7 | 3.5 | 0.8 | 0.000 | 0.42 | bal. | 0.47 | 0.26 | 0.55 | 0.12 | 5.30 | 0.379 |
| body I | Alloy A1 | 0.0025 | 14.6 | 10.2 | 3.6 | 0.0 | 0.821 | 0.43 | bal. | 0.48 | 0.13 | 1.00 | 0.12 | 5.56 | 0.380 |
| | After mixing | | 14.0 | 9.7 | 3.5 | 0.8 | 0.002 | 0.42 | bal. | 0.47 | 0.26 | 0.55 | 0.12 | 5.30 | 0.379 |
| Sintered | Alloy M4 | 1 | 14.0 | 9.7 | 3.5 | 0.8 | 0.000 | 0.42 | bal. | 0.47 | 0.26 | 0.55 | 0.12 | 5.30 | 0.379 |
| body J | | | | | | | | | | | | | | | |
| Sintered | Alloy M5 | 0.9975 | 15.5 | 10.6 | 3.8 | 1.1 | 0.000 | 0.42 | bal. | 0.76 | 0.13 | 1.01 | 0.12 | 5.16 | 0.334 |
| body K | Alloy A1 | 0.0025 | 14.6 | 10.2 | 3.6 | 0.0 | 0.821 | 0.43 | bal. | 0.48 | 0.13 | 1.00 | 0.12 | 5.56 | 0.380 |
| | After mixing | | 15.5 | 10.6 | 3.8 | 1.1 | 0.002 | 0.42 | bal. | 0.76 | 0.13 | 1.01 | 0.12 | 5.16 | 0.334 |
| Sintered | Alloy M5 | 1 | 15.5 | 10.6 | 3.8 | 1.1 | 0.000 | 0.42 | bal. | 0.76 | 0.13 | 1.01 | 0.12 | 5.16 | 0.334 |
| body L | | | | | | | | | | | | | | | |

After that, the alumina crucible was installed in a high-frequency vacuum induction furnace, and the inside of the furnace was substituted with Ar. In addition, the alloy was melted by heating the high-frequency vacuum induction furnace to 1450° C., thereby producing a molten alloy. After that, the molten alloy was poured into a water-cooling copper roll, and a cast alloy was cast using a strip casting (SC) method. At this time, the circumferential velocity of the water-cooling copper roll was set to 1.0 m/second, and the average thickness of the molten alloy was set to approximately 0.3 mm. After that, the cast alloy was crushed, thereby obtaining cast alloy thin pieces of the first alloy and cast alloy thin pieces of the additive alloy (second alloy). Next, the cast alloy thin pieces of the first alloy and the cast alloy thin pieces of the additive alloy (second alloy) were mixed together. The compositions after the mixing are as shown in Table 1.

Next, the cast alloy thin pieces of the first alloy and the cast alloy thin pieces of the additive alloy (second alloy) were mixed together, and then the mixed cast alloy thin pieces were decrepitated using a hydrogen decrepitation method described below. First, the cast alloy thin pieces were coarsely crushed so that the diameter reached approximately 5 mm and were placed in hydrogen at room temperature, whereby hydrogen was adsorbed into the cast alloy thin pieces. Subsequently, a heat treatment in which the cast alloy thin pieces that had been coarsely crushed and absorbed hydrogen were heated up to 300° C. in hydrogen was carried out. After that, hydrogen between lattices in the main phase was degassed by reducing the pressure at from 300° C., furthermore, a heat treatment in which the cast alloy thin pieces were heated up to 500° C. was carried out so as to discharge and remove hydrogen in the grain boundary phase, and the cast alloy thin pieces were cooled to room temperature.

Next, 0.025 wt % of zinc stearate was added as a lubricant to the hydrogen-decrepitated cast alloy thin pieces, and the hydrogen-decrepitated cast alloy thin pieces were finely crushed to an average grain size (d50) of 4 μm using a jet mill (HOSOKAWA MICRON 100 AFG) and high-pressure nitrogen of 0.6 MPa, thereby obtaining R-T-B-based alloy powder.

Next, 0.02% by mass to 0.03% by mass of zinc stearate was added as a lubricant to the R-T-B-based alloy powder obtained in the above-described manner and was pressed using a shaping machine in a traverse magnetic field (magnetic field 2T) at a shaping pressure of 0.8 t/cm², thereby producing a compact.

After that, the compact was installed in a carbon tray, the tray including the compact was disposed in a heat treatment furnace, and the pressure was reduced to 0.01 Pa. Subsequently, the compact was heat treated at three different temperatures of 500° C. for removing an organic substance, 800° C. for decomposing a hydroxide, and 1000° C. to 1100° C. for sintering, thereby obtaining a sintered body (sintering process).

After that, the sintered body was held at 900° C. for 0.75 hours, then, was subjected to a first heat treatment which was quenching, subsequently, was held at 520° C. for one hour, and then was subjected to a second heat treatment which was quenching, thereby obtaining R-T-B-based magnets of Examples 1 to 10 and Comparative Examples 1 to 9. The cooling rates during quenching as the first heat treatment process and the second heat treatment process were set to be equal to each other.

Next, each of the R-T-B-based magnets obtained in Examples 1 to 10 and Comparative Examples 1 to 9 was processed into a cube (6.5 mm×6.5 mm×6.5 mm), and the magnetic properties thereof was measured using a pulse-type BH curve tracer (TMP2-10, Toei Industry Co., Ltd.). The results are shown in Table 2.

TABLE 2

| | | Cooling | | | | |
|---|---|---|---|---|---|---|
| | | rate | Br | Hcj | (BH)max | |
| | | (° C./min) | (kG) | (kOe) | (MGOe) | Hk/Hcj |
| Example 1 | Sintered | 500 | 13.95 | 18.11 | 46.95 | 90.58% |
| | body B | | | | | |
| Example 2 | Sintered | 500 | 13.84 | 18.15 | 46.00 | 91.61% |
| | body C | | | | | |
| Example 3 | Sintered | 1500 | 13.89 | 18.09 | 46.48 | 90.30% |
| | body C | | | | | |
| Example 4 | Sintered | 1000 | 13.85 | 18.03 | 46.52 | 91.70% |
| | body C | | | | | |
| Example 5 | Sintered | 200 | 13.92 | 18.02 | 46.40 | 90.80% |
| | body C | | | | | |
| Example 6 | Sintered | 100 | 13.89 | 18.00 | 46.61 | 91.20% |
| | body C | | | | | |
| Comparative | Sintered | 80 | 13.86 | 17.18 | 46.60 | 91.30% |
| Example 1 | body C | | | | | |
| Comparative | Sintered | 35 | 13.90 | 17.20 | 46.55 | 91.20% |
| Example 2 | body C | | | | | |
| Comparative | Sintered | 500 | 13.91 | 17.49 | 46.56 | 90.61% |
| Example 3 | body A | | | | | |
| Comparative | Sintered | 500 | 13.93 | 17.36 | 46.70 | 90.51% |
| Example 4 | body D | | | | | |
| Comparative | Sintered | 35 | 13.89 | 17.13 | 46.62 | 91.01% |
| Example 5 | body D | | | | | |
| Example 7 | Sintered | 500 | 14.00 | 19.20 | 46.88 | 88.68% |
| | body E | | | | | |
| Comparative | Sintered | 35 | 14.05 | 18.50 | 47.44 | 90.84% |
| Example 6 | body F | | | | | |
| Example 8 | Sintered | 500 | 13.18 | 23.00 | 41.97 | 87.71% |
| | body G | | | | | |
| Comparative | Sintered | 35 | 13.33 | 22.32 | 42.95 | 87.47% |
| Example 7 | body H | | | | | |
| Example 9 | Sintered | 500 | 13.42 | 21.43 | 43.52 | 91.85% |
| | body I | | | | | |
| Comparative | Sintered | 35 | 13.45 | 20.10 | 43.68 | 91.23% |
| Example 8 | body J | | | | | |
| Example 10 | Sintered | 500 | 12.51 | 25.80 | 37.96 | 90.24% |
| | body K | | | | | |
| Comparative | Sintered | 35 | 12.57 | 24.73 | 38.14 | 90.76% |
| Example 9 | body L | | | | | |

In Table 2, “Hcj” represents the coercive force, “Br” represents remanence, “(BH)max” represents the maximum energy product, and “Hk/Hcj” represents squareness based on the ratio between Hk computed as H at which Br reached 90% and Hcj. These magnetic property values are respectively the averages of values measured from three R-T-B-based magnets. In addition, as described above, the cooling rates of the first heat treatment process and the second heat treatment process were equal to each other, and the cooling rates in Table 2 show those equal cooling rates. Meanwhile, the cooling rate of 35° C./minute is rather fast in terms of an ordinary mass production line.

Table 2 shows the following.

Examples 2 to 6 and Comparative Examples 1 and 2 all had the same composition and included 0.002 atom % of Tb. In Examples 2 to 6 in which the cooling rates in the first heat treatment process and the second heat treatment process after the sintering process were 100° C./minute or higher, the coercive forces were all 18 kOe or higher. In contrast, in Comparative Examples 1 and 2 in which the cooling rates were 80° C./minute and 35° C./minute respectively, the coercive forces were 17.18 kOe and 17.20 kOe respectively all of which slightly exceeded 17 kOe and were lower than those of Examples 2 to 6 by approximately 1 kOe.

In addition, in Examples 1 and 2 and Comparative Example 3, the cooling rates in the first heat treatment process and the second heat treatment process after the sintering process were all 500° C./minute, and the amounts of Tb were 0.008 atom %, 0.002 atom %, and 0.016 atom % respectively. In Examples 1 and 2 in which the amount of Tb did not exceed 0.01 atom %, the coercive forces were 18.11 kOe and 18.15 kOe, respectively, all of which exceeded 18 kOe. In contrast, in Comparative Example 3 in which the amount of Tb exceeded 0.01 atom %, the coercive force was 17.49 kOe which was lower than that of Example 1 by approximately 0.6 kOe.

In addition, according to Comparative Examples 4 and 5, in a case in which Tb was not included, the coercive forces slightly exceeded 17 kOe regardless of whether the cooling rates in the first heat treatment process and the second heat treatment process after the sintering process were 35° C./minute which was closer to the cooling rate of an ordinary mass production line or 500° C./minute which was faster than 35° C./minute.

In addition, when Examples 2 and 7 are compared with each other, it is found that, even when the amounts of Tb were equal to each other, the coercive force was improved by setting the amount of Zr to 0.02 atom % which was lower than 0.10 atom % rather than setting the amount of Zr to higher than 0.10 atom %. Additionally, when Example 7 and Comparative Example 6 are compared with each other, it is found that, when the amount of Zr was set to 0.02 atom %, and furthermore, Tb was included, the coercive force was further improved.

In addition, when Examples 7 and 8 are compared with each other, it is found that, even when the amounts of Tb were equal to each other and the amounts of Zr were 0.02 atom % and were thus similar to each other, the coercive force was improved when Dy was included. Additionally, when Example 8 and Comparative Example 7 are compared with each other, it is found that, when the amount of Zr was set to 0.03 atom %, the amount of Dy was set to 0.8 atom %, and furthermore, Tb was included, the coercive force was further improved.

In addition, when Examples 2 and 9 are compared with each other, it is found that, even when the amounts of Tb and the amounts of Zr were equal to each other, the coercive force was improved in a case in which Dy was included.

In addition, when Example 9 and Comparative Example 8 are compared with each other, it is found that, even when the amounts of Dy and the amounts of Zr were equal to each other, the coercive force was improved in a case in which Tb was included more than in a case in which Tb was not included.

In addition, when Examples 9 and 10 are compared with each other, it is found that, even when the amounts of Tb and the amounts of Zr were equal to each other, the coercive force was improved in a case in which a large amount of Dy was included.

In addition, when Example 10 and Comparative Example 9 are compared with each other, it is found that, even when the amounts of Dy and the amounts of Zr were equal to each other, the coercive force was improved in a case in which Tb was included more than in a case in which Tb was not included.

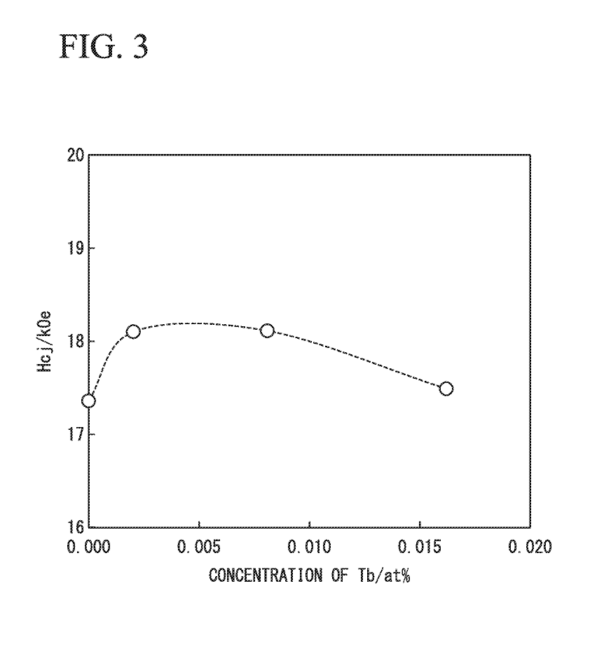

FIG. 3 is a graph illustrating the relationship between the amount of Tb and the coercive force in Examples 1 and 2 and Comparative Examples 3 and 4 which are R-T-B-based magnets to which Dy was not added.

From FIG. 3, it is found that the coercive force gradually increases as the amount of Tb decreases from 0.016 atom %, reaches the maximum at approximately 0.005 atom %, begins to decrease as the amount of Tb decreases from 0.005 atom %, becomes approximately equal at 0.002 atom % to the coercive force (higher than 18 kOe) obtained at 0.008 atom %, furthermore, falls below 18 kOe at approximately 0.0015 atom %, reaches approximately 17.8 kOe at 0.001 atom %, reaches approximately 17.5 kOe at 0.0005 atom %, and reaches 17.36 kOe when Tb is not included.

It is clear from FIG. 3 that, although the amount of Tb is a small amount, the coercive force increases at 0.01 atom % or less.

After each of the samples of the R-T-B-based magnets of Example 1 and Comparative Example 4 was polished, the polished surface was observed using a field emission electron probe micro analyzer (FE-EPMA), and a composition mapping analysis was carried out.

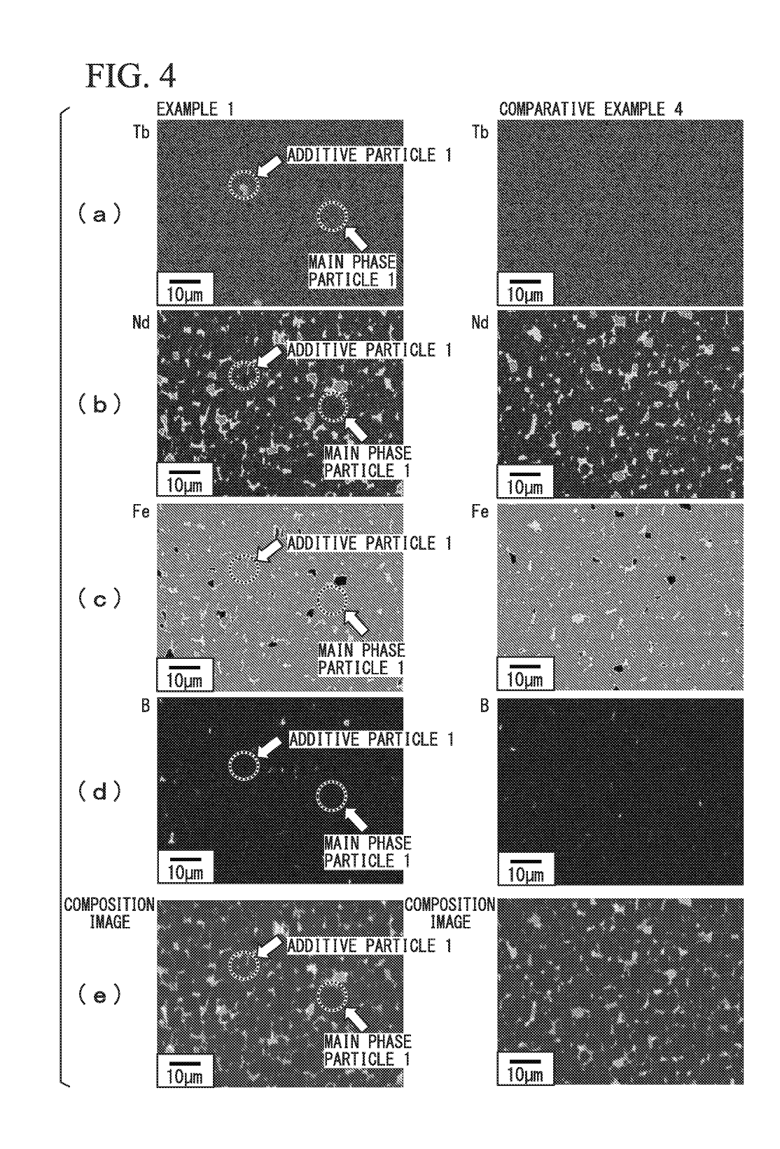

FIG. 4 illustrates the observation results by means of FE-EPMA in which (a) to (e) sequentially illustrate a Tb image, a Nd image, an Fe image, a B image, and a composition image, the images of (a) to (e) on the left side respectively illustrate images of Example 1, and the images on the right side illustrate images of Comparative Example 4. In FIG. 4, the main phase particle 1 and the additive particle 1 respectively indicate a particle in the main phase in the R-T-B-based magnet of Example 1 (composition analysis position) and a particle considered to be derived from the additive alloy (composition analysis position).

Table 3 shows the compositions of the main phase particle 1 and the additive particle 1.

It is found from FIG. 4 and Table 3 that alloy particles including the added Tb remain in the magnet while holding the composition of R₂T₁₄B. In addition, when the amount of the alloy particles including Tb was computed from an image analysis using these images, the amount was approximately 0.01% by area.

TABLE 3
at %

| | TRE | Nd | Pr | Dy | Tb | Al | Fe | Ga | Cu | Co | Zr | B |
|---|---|---|---|---|---|---|---|---|---|---|---|---|
| Main phase | 12.2 | 9.3 | 2.9 | 0.00 | 0.0 | 0.57 | bal. | 0.25 | 0.06 | 1.05 | 0.06 | 5.4 |
| particle 1 | | | | | | | | | | | | |
| Additive | 11.8 | 8.3 | 2.6 | 0.00 | 0.8 | 0.47 | bal. | 0.23 | 0.03 | 1.12 | 0.00 | 5.3 |
| particle 1 | | | | | | | | | | | | |

The additive particle 1 clearly observed in Example 1 of FIG. 4(a) is a Tb-containing particle having a R₂T₁₄B crystal structure and is not observed in Comparative Example 4. The fact that the additive particle 1 has a R₂T₁₄B crystal structure was confirmed using a TEM image.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 . . . manufacturing apparatus, 2 . . . casting device, 3 . . . heating device, 4 . . . storage device, 5 . . . container, 6 . . . chamber, 6a . . . casting chamber, 6b . . . heat retention and storage chamber, 7 . . . hopper, 21 . . . crushing device, 31 . . . heating heater, 32 . . . openable stage group, 33 . . . openable stage.

What is claimed is:

1. An R-T-B-based rare earth sintered magnet comprising:
a rare earth element R, B, a metallic element M which includes one or more metals selected from Al, Ga and Cu, a transition metal T which includes Fe as a main component and inevitable impurities, wherein
the sintered magnet includes:
13 to 15.5 atom % of R,
5.0 to 6.0 atom % of B,
0.1 to 2.4 atom % of M, and
T and the inevitable impurities as a balance,
and wherein
the sintered magnet includes more than 0 atom % and 0.01 atom % or less of Tb as the rare earth element R.

2. The R-T-B-based rare earth sintered magnet according to claim 1, comprising:
particles having a R₂T₁₄B crystal structure including Tb.

3. The R-T-B-based rare earth sintered magnet according to claim 1, wherein the sintered magnet satisfies the following formula (1):
0.32≦B/TRE≦0.40 (1)
wherein, in the formula (1), B represents a concentration (atom %) of a boron element and TRE represents a concentration (atom %) of total rare earth elements.

4. The R-T-B-based rare earth sintered magnet according to claim 1,
wherein the sintered magnet includes 0.015 atom % to 0.10 atom % of Zr as the transition metal T.

5. The R-T-B-based rare earth sintered magnet according to claim 1, comprising:
at least Ga as the metallic element M.

6. A method of manufacturing an R-T-B-based rare earth sintered magnet comprising:
a sintering process of forming a sintered body using an alloy for an R-T-B-based magnet and an additive alloy, wherein
the alloy for an R-T-B-based magnet includes a rare earth element R, B, a metallic element M which includes one or more metals selected from Al, Ga and Cu, a transition metal T which includes Fe as a main component, and inevitable impurities, in which the alloy for an R-T-B-based magnet includes 13 atom % to 15.5 atom % of R, 5.0 atom % to 6.0 atom % of B, 0.1 atom % to 2.4 atom % of M, and T and the inevitable impurities as a balance, and wherein
the additive alloy includes a rare earth element R which essentially includes Tb, B, a metallic element M which includes one or more metals selected from Al, Ga and Cu, a transition metal T which includes Fe as a main component, and inevitable impurities, in which the additive alloy includes 13 atom % to 15.5 atom % of R, 5.0 atom % to 6.0 atom % of B, 0.1 atom % to 2.4 atom % of M, and T and the inevitable impurities as a balance;
a first heat treatment process of putting the sintered body into a heat treatment furnace, carrying out a heat treatment in which the sintered body is held at a temperature in a range of 790° C. to 920° C. for 0.5 hours to 10 hours, and then cooling the sintered body at a cooling rate of 100° C./minute or higher; and
a second heat treatment process of carrying out a heat treatment in which the sintered body that has undergone the first heat treatment is held at a temperature in a range of 480° C. to 620° C. for 0.05 hours to 10 hours, and then cooling the sintered body at a cooling rate of 100° C./minute or higher.

7. The method of manufacturing an R-T-B-based rare earth sintered magnet according to claim 6,
wherein the additive alloy has an R₂T₁₄B crystal phase which includes Tb.

8. The method of manufacturing an R-T-B-based rare earth sintered magnet according to claim 6, wherein the sintered magnet satisfies the following formula (1):
0.32≦B/TRE≦0.40 (1)
wherein, in the formula (1), B represents a concentration (atom %) of a boron element and TRE represents a concentration (atom %) of total rare earth elements.

9. The method of manufacturing an R-T-B-based rare earth sintered magnet according to claim 6,
wherein the alloy for an R-T-B-based magnet does not include Tb.

10. The method of manufacturing an R-T-B-based rare earth sintered magnet according to claim 6,
wherein the method further includes a sub process wherein the alloy for an R-T-B-based magnet and the additive alloy are mixed together in advance prior to the sintering process.

11. The method of manufacturing an R-T-B-based rare earth sintered magnet according to claim 10,
wherein the amount of Tb in a mixture of the alloy for an R-T-B-based magnet and the additive alloy is set to more than 0 atom % and 0.01 atom % or less.
